(19) United States
(12) Patent Application Publication
(10) Pub. No.: US 2019/0340952 A1
(43) Pub. Date: Nov. 7, 2019

(54) SYSTEM FOR LEARNING PROGRAMMING

(71) Applicant: INFITECH CO., LTD., Cheongju-si (KR)

(72) Inventor: Jun Kyu KANG, Cheongju-si (KR)

(73) Assignee: INFITECH CO., LTD., Cheongju-si (KR)

(21) Appl. No.: 16/175,856

(22) Filed: Oct. 31, 2018

(30) Foreign Application Priority Data
May 2, 2018 (KR) 10-2018-0050515
Aug. 1, 2018 (KR) 10-2018-0089940

(51) Int. Cl. G09B 19/00; G09B 19/22; G06F 8/34; G03B 21/00; H04W 4/80

(52) U.S. Cl. CPC G09B 19/0053; G09B 19/22; H04W 4/80; G03B 21/005; G06F 8/34

(57) ABSTRACT

Disclosed is a system for learning programming capable of easily coding a game and learning a coding method, wherein the system includes a web platform including a plurality of game contents, a smart arcade coding box configured to access the web platform and manipulate a game, and a display configured to display an execution screen of the game in connection with the smart arcade coding box, wherein, when a user selects and executes at least one of a plurality of games stored in the web platform using the smart arcade coding box, a programming coding substance of a motion of a character in the game corresponding to a manipulation of the smart arcade coding box is displayed on the display in real time.

### CROSS-REFERENCE TO RELATED APPLICATION

This application claims priority to and the benefit of Korean Patent Application No. 2018-0050515, filed on May 2, 2018 and Korean Patent Application 2018-0089940, filed on Aug. 1, 2018, the disclosure of which is incorporated herein by reference in its entirety.

### BACKGROUND

### 1. Field of the Invention

The present invention relates to a system for learning programming, and more specifically, to a system for learning programming capable of easily coding a game and learning a coding method by visually arranging control buttons.

### 2. Discussion of Related Art

With the coming of 4^{th} industrial revolution era, the importance of software development is gradually growing. In the United Kingdom, the year 2014 was declared as the “Year of Code” and massive campaigns have been conducted for coding education using programming languages, and with the policy making of coding education directly led by the minister, children have been systematically educated since the age of five. In Finland, which is known as educationally advanced country, “koodikerho” was built as a coding school for children aged 4 to 10, and there has also been coding education for elementary school students from 2016.

In Korea, coding education using programming language has been incorporated into curriculum from elementary school to high school. According to the 2015 revised educational curriculum, software education will be selected as a compulsory subject for the fifth and sixth grades of elementary school from 2019. However, there are no specialized educators, related programs, and equipment available.

In addition, the lack of evaluation criteria, the standardized curriculum, and the like are pointed out as limitations. Since currently curriculums and evaluation systems suitable for Korean coding education are not established, there is a possibility that coding education for improvement of creativity and problem solving ability will degenerate into being focused on memorization. In addition, among the programming languages, education in Korea is focused on C language, thus it is difficult to conduct coding education using various programming languages.

### SUMMARY OF THE INVENTION

The present invention is directed to providing a system for learning programming capable of easily coding a game and learning a coding method.

The technical objectives of the present invention are not limited to the above, and other objectives may become apparent to those of ordinary skill in the art based on the following descriptions.

According to an aspect of the present invention, there is provided a system for learning programming, the system including: a web platform including a plurality of game contents; a smart arcade coding box configured to access the web platform and manipulate a game; and a display configured to display an execution screen of the game in connection with the smart arcade coding box, wherein when a user selects and executes at least one of a plurality of games stored in the web platform using the smart arcade coding box, syntaxes of a programming language converted from a programming coding substance of a motion of a character in the game corresponding to a manipulation of the smart arcade coding box and from a block of an execution sequence window are displayed on the display in real time.

The smart arcade coding box may include a manipulator, wherein the manipulator is detachable and attachable and communicates with the smart arcade coding box through a Bluetooth communication so as to manipulate the game in a wireless manner.

The smart arcade coding box may further include a beam projector formed in a central portion thereof, and when the display is not used, the beam projector may display a game screen.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a view illustrating a system for learning programming according to an embodiment of the present invention;

FIG. 2 is a view illustrating an example of a smart arcade coding box shown in FIG. 1;

FIGS. 3 to 6 are views illustrating a method of coding a game according to an embodiment of the present invention;

FIG. 7 is an example view of a syntax converted using a programming language; and

FIG. 8 is a view illustrating a method of coding a game according to another embodiment of the present invention.

### DETAILED DESCRIPTION OF EXEMPLARY EMBODIMENTS

The above objects, features, and advantages of the present invention will become more apparent with reference to descriptions of the following detailed specification when considered in conjunction with the accompanying drawings so that one skilled in the field of the present invention might advantageously implement the spirit of the invention. In the description of the present invention, the detailed description of related known technology will be omitted herein to avoid making the subject matter of the present invention ambiguous

Hereinafter, a system for learning programming according to an embodiment of the present invention will be described with reference to the accompanying drawings.

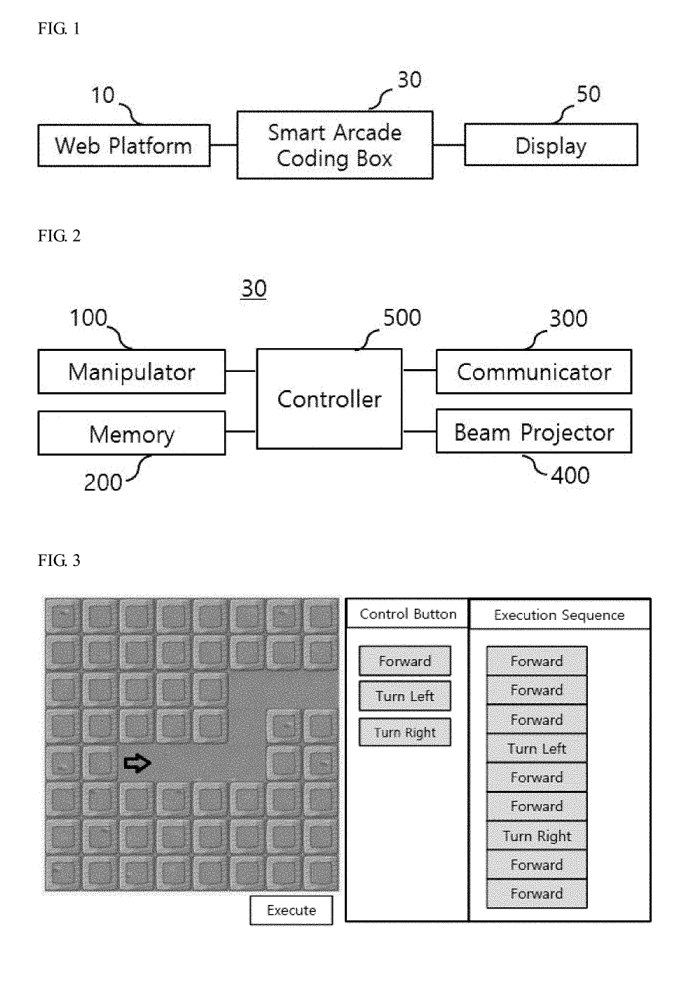

Referring to FIG. 1, the system for learning programming according to the present invention includes a web platform 10, a smart arcade coding box 30, and a display 50.

The web platform 10 is configured to store and provide a plurality of game contents and includes a server connected via a wired/wireless communication network and software operated in the server.

The smart arcade coding box 30 is configured to manipulate a game by accessing the web platform 10, and when a user selects and executes at least one of a plurality of games stored in the web platform 10 using the smart arcade coding box 30, syntaxes of a programming language converted from a programming coding substance (a control button and an execution sequence window) for a motion of a character in the game corresponding to a manipulation of the smart arcade coding box 30 and from a block of the execution sequence window are displayed on the display 50 in real time.

Referring to FIG. 2, the smart arcade coding box 30 includes a manipulator 100, a memory 200, a communicator 300, a beam projector 400, and a controller 500. The manipulator 100 is configured to input a command of a user for moving at least one control button into the execution sequence window and sequentially arranging the at least one control button on the display 50 and configured to input a command of a user for executing a command of the control button. When information is input through the manipulator 100, the controller 500 may control the smart arcade coding box 30 to operate to correspond to the input information. For example, when information is input through the manipulator 100, the controller 500 may control a motion of a character in a game to correspond to the input information. The manipulator 100 may include a mechanical input device (or a mechanical key, such as a button, a mouse, a dome switch, a jog wheel, a jog switch, and the like) and a touch-type input device. For example, the touch-type input device may include a virtual key, a soft key, or a visual key displayed on the display 50, which is implemented in a touch type, through software processing or may include a touch key disposed at an area outside the display 50. Meanwhile, the virtual key or visual key may have various forms, for example, a graphic, a text, an icon, a video, or a combination thereof. In addition, the manipulator 100 may be detachably provided and may be configured to manipulate a game in a wireless manner by communicating with the smart arcade coding box 30 through a Bluetooth communication.

The memory 200 stores data that supports various functions of the system for learning programming according to the present invention. The memory 200 may store a plurality of application programs (application programs or applications) running in the system for learning programming according to the present invention, executed control buttons, and commands of the control buttons converted into a programming language. At least some of the application programs may be downloaded from an external server through a wired/wireless communication by the communicator 300. Meanwhile, the application program may be run according to an operation (or a function) of the smart arcade coding box 30 performed by the controller 500.

In addition, the memory 200 may include at least one type of storage medium among a flash memory type, a hard disk type, a solid state disk (SSD) type, a silicon disk drive (SDD) type, a multimedia card micro type, a card-memory (e.g., a security digital (SD) or XD memory) type, a random access memory (RAM), a static random access memory (SRAM), a read-only memory (ROM), an electrically erasable programmable read-only memory (EEPROM), a programmable read-only memory (PROM), a magnetic memory, a magnetic disk, and an optical disk.

The communicator 300 is configured to perform wired/wireless communication with the web platform 10, another smart arcade coding box 30, a mobile terminal, a server, and the like and includes at least one of a wired communication module, a mobile communication module, a wireless Internet module, and a short range communication module.

For example, the mobile communication module transmits and receives wireless signals to and from at least one of a base station, an external terminal, and a server on a mobile communication network constructed according to technical standards or communication modes for mobile communication (e.g., global system for mobile communication (GSM), code division multi access (CDMA), code division multi access 2000 (CDMA2000), enhanced voice-data optimized or enhanced voice-data only (EV-DO), wideband CDMA (WCDMA), high speed downlink packet access (HSDPA), high speed uplink packet access (HSUPA), long term evolution (LTE), long term evolution-advanced (LTE-A), and the like).

The wireless Internet module refers to a module for wireless Internet access, and may be embedded in or externally connected to a game coding apparatus according to the present invention. The wireless Internet module is configured to transmit and receive wireless signals on a communication network according to wireless Internet technology. Examples of the wireless Internet technology may include Wireless LAN (WLAN), wireless-fidelity (Wi-Fi), wireless fidelity (Wi-Fi) Direct, digital living network alliance (DLNA), wireless broadband (WiBro), world interoperability for microwave access (WiMAX), HSDPA, HSUPA, LTE, LTE-A, and the like. The wireless Internet module transmits and receives data according to at least one wireless Internet technologies in a range including not only the above listed Internet technologies but also other Internet technologies.

The short range communication module is configured to perform short range communication, and may support short range communication using at least one technology among Bluetooth™, radio frequency identification (RFID), infrared data association (IrDA), ultra wideband (UWB), ZigBee, near field communication (NFC), Wi-Fi, Wi-Fi Direct, and wireless Universal Serial Bus (Wireless USB). The short range communication module may support wireless communication with the web platform 10, another smart arcade coding box 30, or a mobile terminal through a short range wireless communication network. In addition, the short range wires communication network may include wireless personal area networks.

The beam projector 400 is formed at the central portion of the smart arcade coding box 30, and when the display 50 is not used, the beam projector 400 may display a game screen according to control of the controller 500.

The controller 500 controls the overall operation of the smart arcade coding box 30 according to the present invention. For example, the controller 500 sequentially executes commands of the respective control buttons according to an arrangement sequence of the control buttons arranged in the execution sequence window displayed on the display 50. In this case, the commands of the control buttons are sequentially executed in units of blocks on the game screen. When two or more control buttons are arranged on the same order in the execution sequence window, the controller 500 simultaneously executes the commands of the control buttons arranged on the same order. As such, when the commands of the control buttons are sequentially executed, the game actually proceeds on the game screen. Accordingly, the game is executed by visually combining the control buttons without a need to construct the game using a programing language.

In addition, the controller 500 may convert the commands of the control buttons sequentially executed into a programming language, for example, Java, JavaScript, Python, C, C++, C#, Ruby, PHP, Perl, and the like, and store the control buttons sequentially executed, the commands converted into a programming language, and the like. In this case, a desired programming language may be selected/set by a user, and the controller 500 may convert the commands of the control buttons using the programming language selected/set by the user. In addition, the commands converted into the selected/set programming language may be stored in the form of syntax. The programming language converted and stored as such forms a game. A user may learn a coding method through the converted programming language.

Referring to FIG. 3, the display 50 is configured to display a game screen including a plurality of blocks (for example, N×N blocks) and one or more control buttons, in which the control buttons may be displayed in a control button window and an execution sequence window. The control button window shows the type of the control button, and the execution sequence window includes the control buttons in a sequence executed in practice. In addition, the display 50 may display a game screen executed according to the command of the control button and a programming language converted according to the command of the executed control button.

The display 50 may include at least one of a liquid crystal display (LCD), a thin film transistor-liquid crystal display (TFT LCD), an organic light-emitting diode (OLED) display, a flexible display, a 3D display, and an e-ink display.

In addition, the display 50 may include a touch sensor that senses a touch on the display 50 to receive a control command by a touch method. Through the above, when a touch is performed on the display 50, the touch sensor senses the touch, and the controller 500 may move and execute a control button corresponding to the touch on the basis of the sensed touch. Substance input by the touch method may be a character or a number, or a menu item that may be indicated or designated in various modes.

Hereinafter, an operation of the system for learning programming according to the embodiment of the present invention will be described in detail.

FIGS. 3 to 6 are views illustrating a method of coding a game for navigating a maze according to an embodiment of the present invention, as an example of a game coding.

First, referring to FIG. 3, a user moves control buttons in the control button window into the execution sequence window to arrange the control buttons in a sequence to be executed using the manipulator 100. For example, the user may arrange the control buttons according to a sequence shown below by dragging or double-clicking the control buttons. In this case, the control button is designated in units of blocks.

“Forward”→“Forward”→“Forward”→“Turn left”→“Forward”→“Forward”→“Turn right”→“Forward”→“Forward”

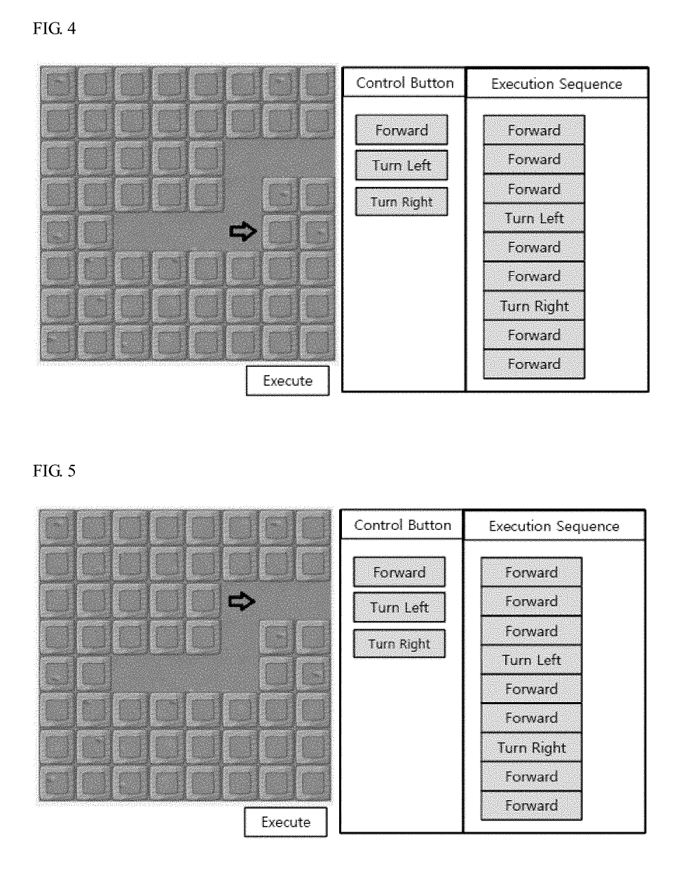

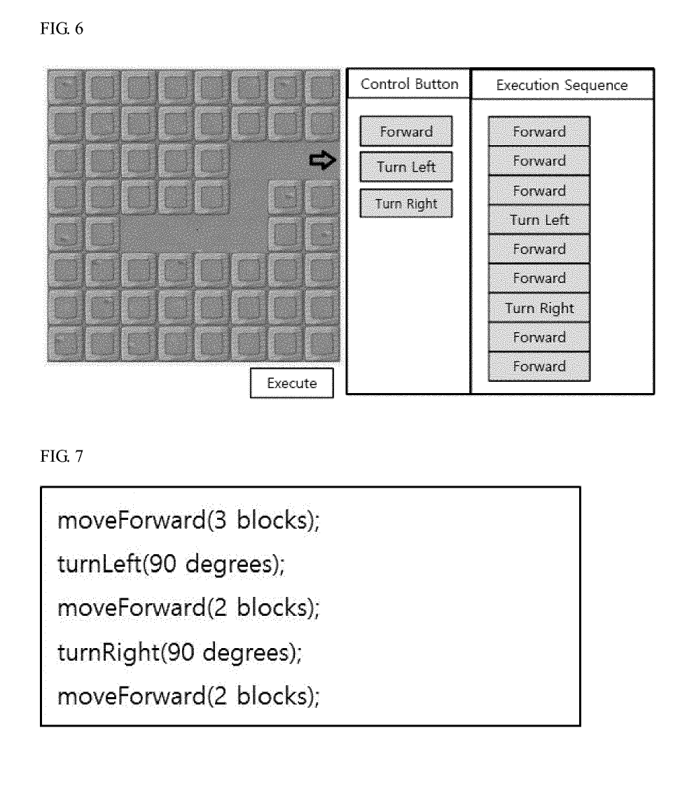

Then, when the user selects an execution button, the controller 500 executes corresponding commands in units of blocks according to the arrangement sequence of the control buttons to thereby move or turn an arrow shown in the game screen. According to the three “Forward” commands in FIG. 4, the arrow moves forward three blocks, according to the “Turn left” command and the two “Forward” commands in FIG. 5, the arrow moves upward two blocks, and according to the “Turn right” command and the two “Forward” commands in FIG. 6, the arrow finally arrives at an exit.

Then, the controller 500 may convert the commands of the control buttons sequentially executed into a programming language when it is determined that the game is operated normally and may store the commands of the executed control buttons, the converted programming language, and the like in at least one of the web platform 10 and the memory 200. The programming language converted and stored as such forms a game.

Referring to FIG. 7, the commands of the control buttons converted into the programming language may be displayed on the display 50, and the user may identify the programming language coded in practice by checking the commands displayed on the display 50.

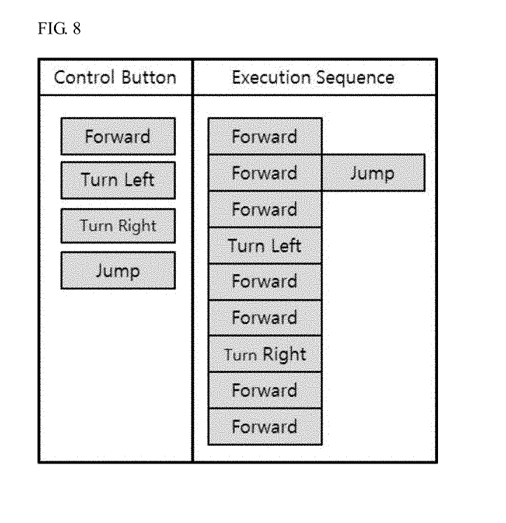

FIG. 8 is a view illustrating a method of coding a game according to another embodiment of the present invention.

Two or more control buttons may be arranged on the same order in the execution sequence window. In this case, the controller 500 may simultaneously execute commands of the control buttons arranged on the same order. For example, “Forward” and “Jump” control buttons arranged on the same order in FIG. 8 may be simultaneously executed, and in this case, the control buttons on the same order are simultaneously applied to a single block.

As is apparent from the above, the system for learning programming according to the present invention can easily code a game by visually arranging control buttons displayed on a screen and can learn a programming language through the result of coding.

Although example embodiments of the disclosure have been shown and described for illustrative purposes, the present invention is not limited to the configuration and effects as illustrated and described, and those skilled in the art should appreciate that various modifications, changes, and substitutions thereto are possible without departing from the scope and spirit of the invention.

What is claimed is:

1. A system for learning programming, the system comprising:
a web platform including a plurality of game contents;
a smart arcade coding box configured to access the web platform and manipulate a game; and
a display configured to display an execution screen of the game in connection with the smart arcade coding box,
wherein, when a user selects and executes at least one of a plurality of games stored in the web platform using the smart arcade coding box, syntaxes of a programming language converted from a programming coding substance of a motion of a character in the game corresponding to a manipulation of the smart arcade coding box and from a block of an execution sequence window are displayed on the display in real time.

2. The system of claim 1, wherein the smart arcade coding box includes a manipulator, wherein the manipulator is detachable and attachable and communicates with the smart arcade coding box through a Bluetooth communication so as to manipulate the game in a wireless manner.

3. The system of claim 1, wherein the smart arcade coding box further includes a beam projector formed in a central portion thereof, and when the display is not used, the beam projector displays a game screen.
